(19) United States
(12) Patent Application Publication
(10) Pub. No.: US 2025/0191053 A1
(43) Pub. Date: Jun. 12, 2025

(54) PREDICTING AVAILABILITIES OF ITEMS AT LOCATIONS BASED ON AVAILABILITY FLUCTUATIONS AT DIFFERENT TIMES OF DAY

(71) Applicant: Maplebear Inc., San Francisco, CA (US)

(72) Inventors: Brent Scheibelhut, Toronto (CA); Charles Wesley, San Diego, CA (US); Hua Xiao, Toronto (CA); Benjamin Chevoor, Toronto (CA); Akshay Bagai, Toronto (CA); Bryan Pham, London (CA)

(21) Appl. No.: 18/532,978

(22) Filed: Dec. 7, 2023

(51) Int. Cl. G06Q 30/0601

(52) U.S. Cl. CPC G06Q 30/0635; G06Q 30/0641

(57) ABSTRACT

An online system displays an ordering interface, and responsive to receiving a request from a client device to place an order including one or more items to be collected from a retailer location, the system retrieves data associated with each item. The system accesses and applies a machine-learning model to predict a likelihood of each item being a predictable availability item having at least a threshold measure of fluctuating availability throughout the day at the retailer location based on data associated with a corresponding item. The system identifies a set of predictable availability items based on the predicted likelihood(s) and predicts an availability of each identified predictable availability item at the retailer location during a future timeframe. The system then updates the ordering interface to describe the predicted availability of each predictable availability item at the retailer location during the future timeframe.

### BACKGROUND

Online systems, such as online concierge systems, allow users to place orders by selecting items to include in the orders and timeframes during which the orders are to be picked up or delivered. The orders are then matched with pickers who service the orders on behalf of the users (e.g., by driving to retailer locations, collecting items included in the orders, and delivering the orders to the users) based on the timeframes selected for the orders. Items included in an order may have availabilities that fluctuate throughout the day at retailer locations. For example, rotisserie chicken prepared at a retailer location at 11:00 a.m. and 3:00 p.m. each day is usually available at the retailer location until it sells out about three hours after it is prepared.

Users who place orders including items having availabilities that fluctuate throughout the day are likely to be dissatisfied with online systems if items included in their orders are collected from retailer locations during times that the items are not available. This is especially true if the users placed the orders for the specific purpose of acquiring these items or if other items included in the orders were ordered based on the assumption that these items would be available. In the above example, suppose that a user orders the rotisserie chicken and several side dishes (e.g., mashed potatoes, roasted vegetables, etc.) for the rotisserie chicken, but the rotisserie chicken is not available. In this example, the user may have to cancel the side dishes, change the order (e.g., to select a replacement item or to meet a minimum delivery requirement), cancel the order, make arrangements to acquire the items elsewhere, etc., which may be time-consuming and inconvenient. As such, users may be less likely to continue placing orders with online systems if they are dissatisfied with the availabilities of items they order.

### SUMMARY

To help users select future timeframes for orders so that items included in the orders are more likely to be available, an online system predicts availabilities of items at retailer locations based on availability fluctuations at different times of day and updates an ordering interface to include information describing the predicted availabilities, in accordance with one or more aspects of the disclosure. More specifically, an online system displays a user interface for placing orders with the online system. Responsive to receiving, via the user interface, a request from a client device associated with a user of the online system to place an order including one or more items to be collected from a retailer location, the online system retrieves a set of data associated with each item. The online system accesses a machine-learning model trained to predict a likelihood that an item is a predictable availability item having at least a threshold measure of fluctuating availability at different times of day at the retailer location. For each item to be included in the order, the online system applies the machine-learning model to predict the likelihood that a corresponding item is a predictable availability item based on the set of data associated with the corresponding item. The online system then identifies a set of predictable availability items to be included in the order based on the likelihood predicted for each item and predicts the availability of each identified predictable availability item at the retailer location during a future timeframe based on the set of data associated with a corresponding predictable availability item. The online system then updates the user interface to include information describing the predicted availability of each identified predictable availability item at the retailer location during the future timeframe.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for predicting an availability of a predictable availability item at a retailer location during a future timeframe, in accordance with one or more embodiments.

FIG. 4 illustrates an example of fluctuations in an availability of an item at different times of day at a retailer location, in accordance with one or more embodiments.

FIGS. 5A-5C illustrate examples of updates to a user interface to include information describing a predicted availability of a predictable availability item at a retailer location during one or more future timeframes, in accordance with one or more embodiments.

### DETAILED DESCRIPTION

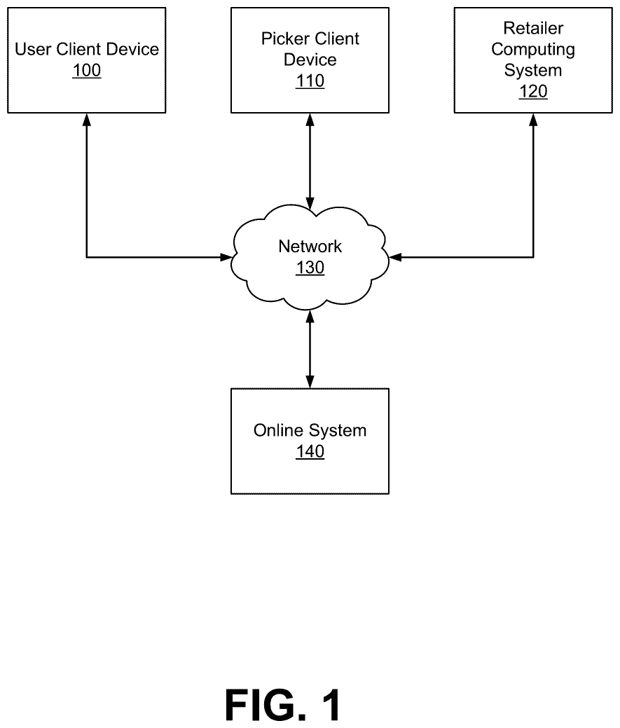

FIG. 1 illustrates an example system environment for an online system 140, such as an online concierge system, in accordance with one or more embodiments. The system environment illustrated in FIG. 1 includes a user client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and retailer computing system 120 are illustrated in FIG. 1, any number of users, pickers, and retailers may interact with the online system 140. As such, there may be more than one user client device 100, picker client device 110, or retailer computing system 120.

The user client device 100 is a client device through which a user may interact with the picker client device 110, the retailer computing system 120, or the online system 140. The user client device 100 can be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to or picked up by the user. An “item,” as used herein, refers to a good or product that may be provided to the user through the online system 140. The order may include item identifiers (e.g., a stock keeping unit (SKU) or a price look-up (PLU) code) for items to be delivered to or picked up by the user and may include quantities of the items to be delivered or picked up. Additionally, an order may further include a delivery location to which the ordered items are to be delivered or a retailer location from which the ordered items are to be picked up and a timeframe during which the items should be delivered or picked up. In some embodiments, the order also specifies one or more retailers from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer location. The picker client device 110 presents the items that are included in the user's order to the picker in a collection interface. The collection interface is a user interface that provides information to the picker identifying items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a user's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a particular retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The user client device 100, the picker client device 110, the retailer computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

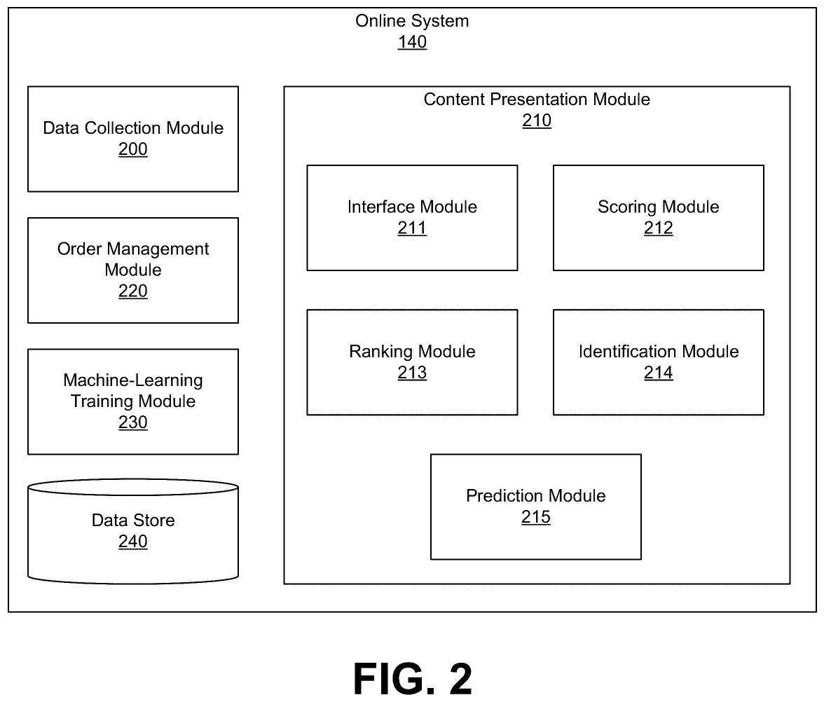

The online system 140 may be an online concierge system by which users can order items to be provided to them by a picker from a retailer. The online system 140 receives orders from a user client device 100 through the network 130. The online system 140 selects a picker to service the user's order and transmits the order to a picker client device 110 associated with the picker. The picker collects the ordered items from a retailer location and delivers the ordered items to the user. The online system 140 may charge a user for the order and provide portions of the payment from the user to the picker and the retailer. As an example, the online system 140 may allow a user to order groceries from a grocery store retailer. The user's order may specify which groceries they want delivered from the grocery store and the quantities of each of the groceries. The user's client device 100 transmits the user's order to the online system 140 and the online system 140 selects a picker to travel to the grocery store retailer location to collect the groceries ordered by the user. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, such as an online concierge system, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

The data collection module 200 collects user data, which is information or data describing characteristics of a user. User data may include a user's name, address, shopping preferences, favorite items, or stored payment instruments. The user data also may include default settings established by the user, such as a default retailer/retailer location, payment instrument, delivery location, or delivery timeframe. The user data also may include information describing interactions by a user with the online system 140. For example, user data may include information describing orders a user has requested to place with the online system 140, such as information describing items to be included in each order (e.g., items that were added to a shopping list associated with the user), a time at which the user requested to place each order, etc. As an additional example, user data may include information describing interactions by a user with items or other content (e.g., recipes, coupons, advertisements, etc.) presented by the online system 140. In the above example, the information may describe the items/content (e.g., item or recipe types), the types of interactions (e.g., adding items to a shopping list, requesting to place an order with the online system 140, searching for or browsing items, clicking on an advertisement, etc.), and the times of the interactions (e.g., a timestamp associated with each interaction). In some embodiments, user data is collected in real time by the data collection module 200. The data collection module 200 may collect the user data from sensors on the user client device 100 or based on the user's interactions with the online system 140.

The data collection module 200 also collects item data, which is information or data identifying and describing items that are available at a retailer location. The item data may include item identifiers for items that are available and may include quantities of items associated with each item identifier. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties (e.g., flavors, low fat, gluten-free, organic, etc.), or any other suitable attributes of the items. The item data may further include purchasing rules associated with each item, if they exist. For example, age-restricted items such as alcohol and tobacco are flagged accordingly in the item data.

Item data may also include information that is useful for predicting the availability of items at retailer locations. Examples of such types of information include: historical supply and demand data associated with the online system 140, historical or current availability data associated with items (e.g., for different retailer locations, times of day, days of the week, holidays, seasons, etc.), or any other suitable types of information. For example, the item data may include information describing shifts in demand (e.g., for various brands or types of items from various retailer locations due to emerging trends) and supply (e.g., due to shortages, surpluses, recalls, etc.). As an additional example, for each item-retailer combination (a particular item at a particular retailer location), the item data may include a time that the item was last found, a time that the item was last not found (a picker looked for the item but could not find it), the rate at which the item is found, or the popularity of the item. In the above example, for each item-retailer combination, the item data also may include a quantity of the item that was previously or last restocked, a quantity of the item that is currently available or scheduled to be restocked, a rate at which the item is restocked, a quantity of the item that was ordered or purchased, a rate at which the item is ordered or purchased, etc. and a time (e.g., a timestamp or a timespan) associated with each quantity or rate.

In some embodiments, the item data includes a measure of fluctuation of an availability of an item at different times of day at a retailer location. The fluctuation may be measured in various ways, such as a standard deviation, a range, a difference, a ratio, a rate, or any other suitable measure. For example, a measure of fluctuation of an availability of an item at different times of day at a retailer location may correspond to a standard deviation computed based on data points describing the average availability of the item at the retailer location at different times of the day (e.g., for every hour, every 30 minutes, every 10 minutes, etc.). In the above example, the measure of fluctuation also may correspond to a range of the average availability computed based on the data points. Alternatively, in the above example, the measure of fluctuation may correspond to a difference between a largest average hourly availability of the item at the retailer location and an average daily availability of the item at the retailer location. As another alternative, in the above example, the measure of fluctuation may correspond to a ratio of the largest average hourly availability of the item at the retailer location to the average daily availability of the item at the retailer location. As an additional example, a measure of fluctuation of an availability of an item at different times of day at a retailer location may correspond to a rate at which an average hourly availability of the item changes throughout the day at the retailer location.

In various embodiments, the item data also includes information indicating whether an item is a predictable availability item. A predictable availability item is associated with a measure of fluctuation of availability at different times of day at a retailer location that is at least a threshold measure. Furthermore, an availability of a predictable availability item at a retailer location is predictable for different times of the day. Items that are predictable availability items may be more likely to be prepared each day at a retailer location than items that are not predictable availability items, such that predictable availability items may be restocked each day (e.g., at regular time intervals or at scheduled times throughout the day) at the retailer location. For example, predictable availability items may include pastries that are baked early in the morning and often sell out by the late morning each day at a retailer location. As an additional example, predictable availability items may include rotisserie chicken that is prepared at 2:00 p.m. and often sells out by 6:00 p.m. each day at a retailer location. Furthermore, items that are predictable availability items also may be more likely to be priced below market cost to attract users and stimulate sales of other items than items that are not predictable availability items. Information indicating whether an item is a predictable availability item may be received from a user client device 100 in response to a prompt, a questionnaire, a survey, etc., as described below. The data collection module 200 may collect item data from a retailer computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as soy sauce, ramen, and miso soup may be included in an “Asian foods” item category. As an additional example, items that are priced below market cost to attract users and stimulate sales of other items may be included in a “loss leader” item category, while items that are freshly prepared each day (e.g., freshly prepared chicken, pastries, deli sandwiches, etc.) may be included in a “fresh made” item category. Furthermore, in various embodiments, an item may be included in multiple categories. For example, organic strawberries may be included in an “organic strawberries” item category, a “strawberries” item category, and an “organic fruit” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the retailers from which the picker has collected items, or the picker's previous shopping history. Additionally, the picker data may include preferences expressed by the picker, such as their preferred retailers for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a retailer location from which the user wants the ordered items collected, or a timeframe within which the user wants the order delivered. Order data may further include information describing how an order was serviced, such as which picker serviced the order, when the order was delivered, or a rating that the user gave the delivery of the order. Order data also may include information describing problems associated with an order, such as whether a refund issued for an item included in an order was associated with an issue, a cancellation, a complaint, or a low rating associated with the order or with one or more additional items being removed from the order. In some embodiments, the order data includes user data for users associated with the order, such as user data for a user who placed the order or picker data for a picker who serviced the order.

The content presentation module 210 selects content for presentation to a user. For example, the content presentation module 210 selects which items to present to a user while the user is placing an order. Components of the content presentation module 210 include: an interface module 211, a scoring module 212, a ranking module 213, an identification module 214, and a prediction module 215, which are further described below.

The interface module 211 generates and transmits an ordering interface for a user to order items. The interface module 211 populates the ordering interface with items that the user may select for adding to their order (e.g., by adding the items to a shopping list and communicating a request to the online system 140 to place an order including the items). In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the identification module 214 may identify items with scores that exceed some threshold (e.g., the top n items or the p percentile of items) and the interface module 211 then displays the identified items. The interface module 211 also may update the ordering interface to include information describing a predicted availability of a predictable availability item at a retailer location during a future timeframe, as described below.

The interface module 211 also may receive information from a user client device 100, a picker client device 110, or a retailer computing system 120 indicating whether an item is a predictable availability item. The interface module 211 may receive this information in response to a prompt, a questionnaire, a survey, etc. that asks for information that may indicate whether an item is a predictable availability item (e.g., whether it is freshly prepared, whether its availability fluctuates throughout the day, an importance of its availability, etc.). For example, the interface module 211 may generate a prompt that asks a user whether any items to be included in an order that the user has requested to place with the online system 140 are freshly prepared items. In this example, in response to sending the prompt to a user client device 100 associated with the user, the interface module 211 may receive a response from the user client device 100 indicating whether one or more items to be included in the order are freshly prepared items and are therefore also likely to be predictable availability items. Alternatively, in the above example, if the prompt asks the user to verify whether one or more items to be included in the order that the identification module 214 has identified as predictable availability items (as described below) are freshly prepared items, and the response from the user client device 100 verifies this, the response may also indicate the item is a predictable availability item. As an additional example, the interface module 211 may generate a prompt that asks a user which items to be included in an order that the user has requested to place with the online system 140 are items that the user needs rather than wants, and send the prompt to a user client device 100 associated with the user. In the above example, since an availability of a predictable availability item is also likely to be more important to the user than that of other items due to its fluctuating daily availability, a response to the prompt received from the user client device 100 identifying a set of items that the user needs also may indicate that each identified item is a predictable availability item.

The scoring module 212 may use an item selection model to score items for presentation to a user. An item selection model is a machine-learning model that is trained to score items for a user based on item data for the items and user data for the user. For example, the item selection model may be trained to determine a likelihood that the user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a search query received from the user client device 100. A search query is free text for a word or set of words that indicate items of interest to the user. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a user (e.g., by comparing a search query embedding to an item embedding).

In some embodiments, the scoring module 212 scores items based on a predicted availability of an item. The scoring module 212 may use an item availability model to predict the availability of an item. An item availability model is a machine-learning model that is trained to predict the availability of an item at a particular retailer location. For example, the item availability model may be trained to predict a likelihood that an item is available at a retailer location or may predict an estimated number of items that are available at a retailer location. The scoring module 212 may apply a weight to the score for an item based on the predicted availability of the item. Alternatively, the items may be filtered out from presentation to a user based on whether the predicted availability of the item exceeds a threshold.

In addition to identifying items with scores that exceed some threshold, the identification module 214 also may identify predictable availability items. The identification module 214 may identify a predictable availability item based on a likelihood that the item is a predictable availability item. This likelihood may be predicted by the prediction module 215, as described below. For example, the identification module 214 may compare a predicted likelihood that an item is a predictable availability item to a threshold likelihood and identify the item as a predictable availability item if the likelihood is at least the threshold likelihood.

The identification module 214 also may identify a set of future timeframes associated with an order. A future timeframe associated with an order may correspond to a delivery timeframe during which the order may be delivered to a user associated with a user client device 100 from which a request to place the order was received or a pickup timeframe during which the order may be picked up by the user from a retailer location. Various types of future timeframes associated with an order may be identified by the identification module 214. For example, the identification module 214 may identify future timeframes associated with an order that include an expedited or priority timeframe (e.g., within the next hour), a standard timeframe (e.g., between the next two hours and the next four hours), and one or more timeframes that span a specific number of hours (e.g., two or three hours). In this example, the timeframes identified by the identification module 214 also may include an ETA-based timeframe (e.g., based on an estimated time that a user who placed the order will arrive at a retailer location to pick up the order or an estimated time that a picker servicing the order will arrive at a delivery location to deliver the order). The identification module 214 may identify a set of future timeframes associated with an order based on various types of information. Examples of such types of information include: a retailer location from which one or more items to be included in the order is/are to be collected, a time associated with the order (e.g., time of day, day of the week, etc.), whether pickers are available to service the order, a number of items to be included in the order, a default timeframe associated with a user associated with the order, or any other suitable types of information.

The prediction module 215 may retrieve a set of data (e.g., item data, user data, order data, etc.) from the data store 240 associated with an item that may be used to predict a likelihood that the item is a predictable availability item. The prediction module 215 may do so in response to receiving a request from a user client device 100 associated with a user to place an order including the item with the online system 140 (e.g., based on an item identifier associated with the item). As described above, a predictable availability item is associated with a measure of fluctuation of availability at different times of day at a retailer location that is at least a threshold measure and an availability of a predictable availability item at a retailer location is predictable for different times of the day. As also described above, items that are predictable availability items may be more likely to be prepared each day at a retailer location and to be priced below market cost to attract users and stimulate sales of other items than items that are not predictable availability items. For example, the prediction module 215 may retrieve a set of data associated with an item describing whether the item is included in a “loss leader” or a “fresh made” item category, as well as a measure of fluctuation of an availability of the item at different times of day at a retailer location. Due to its fluctuating daily availability, an availability of a predictable availability item is also likely to be more important to users than that of other items, such that information that may be used to predict a likelihood that an item is a predictable availability item may indicate whether previous orders including the item were placed primarily for the purpose of acquiring it. For example, a set of data associated with an item may indicate whether a refund issued for the item was associated with an issue, a cancellation, a complaint, or a low rating associated with one or more previous orders. In the above example, the set of data also may indicate whether a refund issued for the item was associated with one or more additional items being removed from one or more previous orders, whether the item was the first item added to one or more shopping lists, etc.

The prediction module 215 may predict a likelihood that an item is a predictable availability item based on data associated with the item retrieved from the data store 240. For example, suppose that a set of data associated with an item indicates whether refunds issued for the item were associated with issues, cancellations, complaints, or low ratings associated with previous orders, or with one or more additional items being removed from previous orders. In this example, the prediction module 215 may predict a likelihood that the item is a predictable availability item based on the set of data, in which the predicted likelihood is proportional to a number of times or a rate at which refunds issued for the item were associated with issues, cancellations, complaints, or low ratings associated with previous orders, or with one or more additional items being removed from previous orders. In the above example, suppose that the set of data associated with the item also indicates whether the item was the first item added to shopping lists and whether the item is included in a “loss leader” or a “fresh made” item category. Continuing with this example, the likelihood predicted by the prediction module 215 also may be proportional to a percentage of previous orders in which the item was the first item added to a shopping list and the likelihood may be higher if the item is included in a “loss leader” or a “fresh made” item category than if it is not. In the above example, if the set of data associated with the item also describes a measure of fluctuation of an availability of the item at different times of day at a retailer location, the likelihood predicted by the prediction module 215 also may be proportional to the measure of fluctuation.

The prediction module 215 may predict a likelihood that an item is a predictable availability item using a predictable availability item prediction model. The predictable availability item prediction model is a machine-learning model trained to predict a likelihood that an item is a predictable availability item. In some embodiments, the predictable availability item prediction model is a multi-task model that predicts a likelihood that each item to be included in an order that a user of the online system 140 has requested to place with the online system 140 is a predictable availability item. In other embodiments, the predictable availability item prediction model predicts the likelihood for a particular item to be included in the order. To use the predictable availability item prediction model, the prediction module 215 may access the model (e.g., from the data store 240) and apply the model to a set of inputs. The set of inputs may include various types of data associated with an item. For example, the set of inputs may indicate whether refunds issued for an item were associated with issues, cancellations, complaints, or low ratings associated with previous orders, or with one or more additional items being removed from previous orders. In this example, the set of inputs also may indicate whether the item was the first item added to shopping lists and whether the item is included in a “loss leader” or a “fresh made” item category. Continuing with this example, the set of inputs also may describe a measure of fluctuation of an availability of the item at different times of day at a retailer location. Once the prediction module 215 applies the predictable availability item prediction model to a set of inputs, the prediction module 215 may receive an output from the model corresponding to a likelihood that an item is a predictable availability item. Continuing with the above example, the output received by the prediction module 215 may correspond to a value, such as a percentage, a score, etc. that indicates or is proportional to a likelihood that the item is a predictable availability item. In some embodiments, the predictable availability item prediction model may be trained by the machine-learning training module 230, as further described below.

The prediction module 215 also may predict an availability of a predictable availability item at a retailer location during a future timeframe. For example, the prediction module 215 may predict an availability of an item identified by the identification module 214 as a predictable availability item at a retailer location during a future timeframe. In some embodiments, the prediction module 215 also predicts an availability of an item if the interface module 211 has received information indicating the item is a predictable availability item. A predicted availability of a predictable availability item at a retailer location during a future timeframe may correspond to a likelihood that the predictable availability item is available at the retailer location during the future timeframe or a number of the predictable availability item predicted to be available at the retailer location during the future timeframe. For example, a predicted availability of a predictable availability item at a retailer location during a future timeframe may describe a likelihood that the predictable availability item will be available at the retailer location when a picker will be collecting the predictable availability item from the retailer location based on the future timeframe (e.g., time of day, whether it is a pickup or a delivery timeframe, etc.). Alternatively, in the above example, the predicted availability may describe a number of the predictable availability item predicted to be available at the retailer location when the picker will be collecting the predictable availability item from the retailer location based on the future timeframe.

The prediction module 215 may predict an availability of a predictable availability item at a retailer location during a future timeframe based on a set of data associated with the predictable availability item. As described above, data associated with an item may include historical or current availability data associated with the item (e.g., for different retailer locations, times of day, days of the week, holidays, seasons, etc.). The prediction module 215 also may predict an availability of a predictable availability item at a retailer location during a future timeframe based on information describing the future timeframe, the retailer location, or any other suitable types of information. For example, the prediction module 215 may predict an availability of a predictable availability item at a retailer location during a future timeframe based on a time of day, day of the week, a holiday, a season, etc. associated with the future timeframe, an item identifier, item category, etc. associated with the predictable availability item, and a name of a retailer and a geographical region associated with the retailer location.

To illustrate an example of how the prediction module 215 may predict an availability of a predictable availability item at a retailer location during a future timeframe, suppose that the prediction module 215 retrieves a set of data associated with the predictable availability item. In this example, suppose also that the set of data describes, for the retailer location, one or more quantities associated with the predictable availability item (e.g., a quantity of the predictable availability item that was previously or last restocked, purchased, or ordered, a quantity of the predictable availability item that is currently available or scheduled to be restocked, etc.) and a time (e.g., a timestamp or a timespan) associated with each quantity. In this example, suppose also that the set of data describes, for the retailer location, one or more rates associated with the predictable availability item (e.g., a rate at which it is restocked, ordered, purchased, etc.) and a time (e.g., a timestamp or a timespan) associated with each rate. Continuing with this example, the prediction module 215 may predict an availability of the predictable availability item at the retailer location during a future timeframe that is proportional to a quantity of the predictable availability item that is currently available, a quantity of the predictable availability item that was previously, last, or scheduled to be restocked, and the rate at which it is restocked. In the above example, the predicted availability also may be proportional to a difference between a sum of the quantities of the predictable availability item that were purchased/ordered after the predictable availability item was previously/last restocked and a quantity of the predictable availability item that was previously/last restocked. Continuing with the above example, the predicted availability also may be inversely proportional to an amount of time between the time that the predictable availability item was previously, last, or scheduled to be restocked and the future timeframe. In the above example, if the set of data also includes real-time information describing quantities of the predictable availability item included in shopping lists associated with users, such that if each user places an order, the predictable availability item and any other items included in the shopping lists are to be collected from the retailer location, the predicted availability also may be inversely proportional to a sum of the quantities.

In various embodiments, the prediction module 215 predicts an availability of a predictable availability item at a retailer location during multiple future timeframes. For example, suppose that a request is received from a user client device 100 to place an order including a predictable availability item and that the identification module 214 has identified three future timeframes associated with the order. In this example, the prediction module 215 may, by default, predict an availability of the predictable availability item at a retailer location from which one or more items to be included in the order are to be collected during each of the future timeframes. Alternatively, in the above example, the prediction module 215 may predict an availability of the predictable availability item at the retailer location during the future timeframes in response to receiving a selection of a future timeframe from the user client device 100, as further described below.

The prediction module 215 also may predict an availability of a predictable availability item at a retailer location during a future timeframe using a retailer-timeframe availability model. The retailer-timeframe availability model is a machine-learning model trained to predict an availability of a predictable availability item at a retailer location during a future timeframe. In some embodiments, the retailer-timeframe availability model is a multi-task model that predicts, for a retailer location during each of a set of future timeframes, an availability of each predictable availability item to be included in an order. In other embodiments, the retailer-timeframe availability model predicts, for a retailer location during a particular future timeframe, an availability of a particular predictable availability item to be included in an order.

To use the retailer-timeframe availability model, the prediction module 215 may access the model (e.g., from the data store 240) and apply the model to a set of inputs. The set of inputs may include various types of data associated with a predictable availability item, information describing a future timeframe, a retailer location, or any other suitable types of information. For example, the set of inputs may include a time of day, day of the week, a holiday, a season, etc. associated with a future timeframe, an item identifier, item category, etc. associated with a predictable availability item, and a name of a retailer and a geographical region associated with a retailer location. As an additional example, the set of inputs may include historical or current availability data associated with a predictable availability item at a retailer location (e.g., for different times of day, days of the week, holidays, seasons, etc.). In this example, the set of inputs may include a time that the predictable availability item was last found at the retailer location, a time that it was last not found at the retailer location, a rate at which it is found at the retailer location, and its popularity at the retailer location. In the above example, the set of inputs also may include one or more quantities associated with the predictable availability item for the retailer location (e.g., a quantity of the predictable availability item that was previously or last restocked, purchased, or ordered, a quantity of the predictable availability item that is currently available or scheduled to be restocked, etc.) and a time (e.g., a timestamp or a timespan) associated with each quantity. In this example, the set of inputs also may include, for the retailer location, one or more rates associated with the predictable availability item (e.g., a rate at which it is restocked, ordered, purchased, etc.) and a time (e.g., a timestamp or a timespan) associated with each rate. Additionally, in the above example, the set of inputs may include real-time information describing quantities of the predictable availability item included in shopping lists associated with users, such that if each user places an order, the predictable availability item and any other items included in the shopping lists are to be collected from the retailer location.

Once the prediction module 215 applies the retailer-timeframe availability model to a set of inputs, the prediction module 215 may receive an output from the model corresponding to a predicted availability of a predictable availability item at a retailer location during a future timeframe. Continuing with the above example, the output received by the prediction module 215 may correspond to a value, such as a percentage, a score, etc. that indicates or is proportional to a predicted availability of the predictable availability item at the retailer location during a future timeframe. In some embodiments, the retailer-timeframe availability model may be trained by the machine-learning training module 230, as further described below. In embodiments in which the interface module 211 receives information indicating an item is a predictable availability item, the prediction module 215 predicts an availability of the item in a manner analogous to that described above.

Once the prediction module 215 predicts an availability of a predictable availability item at a retailer location during a future timeframe, the interface module 211 may update the ordering interface to include information describing the predicted availability. In embodiments in which the interface module 211 receives information indicating an item is a predictable availability item and the prediction module 215 predicts an availability of the item, the interface module 211 updates the ordering interface to include information describing the predicted availability. The interface module 211 may update the ordering interface with text, images (e.g., graphs), videos, animations, or any other suitable types of content. For example, suppose that during a future timeframe that is between the next 48 and 58 minutes, the prediction module 215 has predicted an availability of a predictable availability item corresponding to barbecue flavored chicken at a retailer location and that the predicted availability is less than a threshold predicted availability. In this example, if a user selects this future timeframe, the interface module 211 may update the ordering interface to include information indicating that the barbecue flavored chicken will likely be out of stock at the retailer location during the selected future timeframe. In the above example, the interface module 211 also may update the ordering interface to suggest that the user select a different timeframe. In embodiments in which an order includes multiple predictable availability items, the interface module 211 updates the ordering interface to include information describing the predicted availabilities of the predictable availability items at a retailer location during a future timeframe (e.g., by including an average predicted availability of the predictable availability items or a predicted availability of each predictable availability item).

The interface module 211 may also update the ordering interface to include information describing a predicted availability of a predictable availability item at a retailer location during multiple future timeframes. Continuing with the above example, in response to receiving a request from a user client device 100 associated with the user to select a different timeframe, the interface module 211 may update the ordering interface to include a window with a graph illustrating the predicted availability of the barbecue flavored chicken during different timeframes. In this example, the window also may include various options associated with the barbecue flavored chicken (e.g., to select a replacement, to remove it, etc.) or the timeframes (e.g., to select a different timeframe, to allow the online system 140 to select a different timeframe, etc.). Alternatively, in the above example, a future timeframe associated with the greatest predicted availability may be selected by default in the ordering interface and the interface module 211 may update the ordering interface to include the window with the graph illustrating the predicted availability of the barbecue flavored chicken during different timeframes in response to receiving a selection of a different future timeframe. As another alternative, in the above example, the future timeframe associated with the greatest predicted availability may be highlighted within the ordering interface or the future timeframes may be positioned within the ordering interface based on their associated predicted availabilities, such that the future timeframe associated with the greatest predicted availability is in a most prominent position of the ordering interface. In this example, the interface module 211 may update the ordering interface to include the window with the graph illustrating the predicted availability of the barbecue flavored chicken during different timeframes in response to receiving a selection of a future timeframe that is not highlighted or in the most prominent position of the ordering interface.

The order management module 220 manages orders for items from users. The order management module 220 receives orders from user client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by users, or how often a picker agrees to service an order. In some embodiments, a retailer location from which items included in an order are to be collected is specified in the order (e.g., by a user associated with the order), while in other embodiments, the order management module 220 determines the retailer location. For example, based on a retailer specified by a user associated with an order and a delivery location associated with the user, the order management module 220 may determine a retailer location operated by the retailer from which items included in the order are to be collected.

In some embodiments, the order management module 220 determines when to assign an order to a picker based on a delivery timeframe requested by the user who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine-learning training module 230 trains machine-learning models used by the online system 140. The online system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

In embodiments in which the prediction module 215 accesses and applies the predictable availability item prediction model to predict a likelihood that an item is a predictable availability item, the machine-learning training module 230 may train the predictable availability item prediction model. The machine-learning training module 230 may train the predictable availability item prediction model via supervised learning or using any other suitable technique or combination of techniques. The machine-learning training module 230 may do so based on data (e.g., item data, user data, order data, etc.) associated with items included among the inventory of one or more retailers or retailer locations associated with the online system 140.

To illustrate an example of how the machine-learning training module 230 may train the predictable availability item prediction model, suppose that the machine-learning training module 230 receives a set of training examples. In this example, the set of training examples may include various attributes of items included among an inventory of a retailer location associated with the online system 140, such as whether refunds issued for each item were associated with issues, cancellations, complaints, or low ratings associated with previous orders, or with one or more additional items being removed from previous orders. In this example, the attributes of each item also may indicate whether the item was the first item added to shopping lists and whether the item is included in a “loss leader” or a “fresh made” item category. In the above example, the machine-learning training module 230 also may receive labels which represent expected outputs of the predictable availability item prediction model, in which a label indicates whether an item is a predictable availability item. In this example, the label may indicate the item is a predictable availability item if a measure of fluctuation of an availability of the item at different times of day at the retailer location is at least a threshold measure. Continuing with this example, the machine-learning training module 230 may then train the predictable availability item prediction model based on the attributes, as well as the labels by comparing its output from input data of each training example to the label for the training example.

In embodiments in which the prediction module 215 accesses and applies the retailer-timeframe availability model to predict an availability of a predictable availability item or other item at a retailer location during a future timeframe, the machine-learning training module 230 may train the retailer-timeframe availability model. The machine-learning training module 230 may train the retailer-timeframe availability model via supervised learning or using any other suitable technique or combination of techniques based on data (e.g., item data, user data, order data, etc.) associated with items included among the inventory of one or more retailers or retailer locations associated with the online system 140. Examples of such types of data include: historical or current availability data associated with predictable availability items (e.g., for different retailer locations, times of day, days of the week, holidays, seasons, etc.), historical supply and demand data associated with the online system 140 (e.g., information describing shifts in demand from users, information describing changes in supply chains, etc.), or any other suitable types of data. The machine-learning training module 230 also may train the retailer-timeframe availability model based on additional types of information, such as user data (e.g., historical interaction information), information describing previous timeframes, retailer locations, or any other suitable types of information.

To illustrate an example of how the machine-learning training module 230 may train the retailer-timeframe availability model, suppose that the machine-learning training module 230 receives a set of training examples. In this example, the set of training examples may include various attributes of predictable availability items included among an inventory of a retailer location associated with the online system 140, such as times that each predictable availability item was found at the retailer location, times that it was not found at the retailer location, a rate at which it was found at the retailer location, and its popularity at the retailer location. In this example, the attributes also may include one or more quantities associated with each predictable availability item (e.g., a quantity of the predictable availability item that was previously restocked, purchased, or ordered, etc.), one or more rates associated with the predictable availability item (e.g., a rate at which it was restocked, ordered, purchased, etc.), and a time (e.g., a timestamp or a timespan) associated with each quantity or rate. Additionally, in the above example, the attributes of each predictable availability item also may include attributes that may have potentially affected the availability of each predictable availability item at the retailer location (e.g., a quantity of the predictable availability item included in shopping lists associated with users, such that if each user placed an order, the predictable availability item and any other items included in the shopping lists were collected from the retailer location). In the above example, the machine-learning training module 230 also may receive labels which represent expected outputs of the retailer-timeframe availability model, in which a label indicates an availability of a predictable availability item at a retailer location during a timeframe (e.g., as a value, a percentage, a score, etc. that corresponds to or is proportional to the availability). Continuing with this example, the machine-learning training module 230 may then train the retailer-timeframe availability model based on the attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In situations in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

### Predicting an Availability of a Predictable Availability Item at a Retailer Location During a Future Timeframe

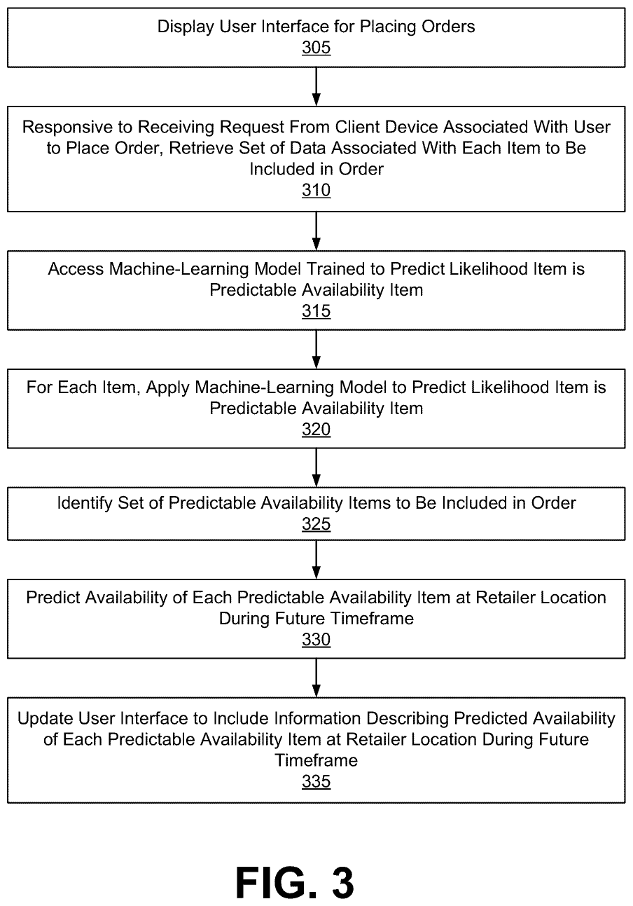

FIG. 3 is a flowchart for a method for predicting an availability of a predictable availability item at a retailer location during a future timeframe, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online concierge system. Additionally, each of these steps may be performed automatically by the online system 140 without human intervention.

The online system 140 displays 305 (e.g., using the interface module 211) the ordering interface for placing orders with the online system 140. For example, the online system 140 displays 305 the ordering interface for users to order items by generating (e.g., using the interface module 211) the ordering interface and sending (e.g., using the interface module 211) the ordering interface to user client devices 100 associated with the users. As described above, the ordering interface is populated with items that users may select for adding to their orders (e.g., by adding the items to shopping lists and communicating requests to the online system 140 to place orders including the items). In some embodiments, the ordering interface presents a catalog of all items that are available to users, which the users can browse to select items to order.

The online system 140 then receives (e.g., via the interface module 211), via the ordering interface, a request from a user client device 100 associated with a user of the online system 140 to place an order including one or more items with the online system 140, in which the item(s) is/are to be collected from a retailer location. The request to place the order may indicate whether the order is a pickup order that the user will pick up from the retailer location or a delivery order that will be delivered to a delivery location associated with the user. In some embodiments, the retailer location is specified in the order (e.g., by the user), while in other embodiments, the online system 140 determines the retailer location (e.g., using the order management module 220). For example, based on a retailer specified by the user and a delivery location associated with the user, the online system 140 may determine the retailer location operated by the retailer from which the item(s) to be included in the order are to be collected.

Responsive to receiving the request to place the order, the online system 140 retrieves 310 (e.g., using the prediction module 215) a set of data associated with each item to be included in the order (e.g., from the data store 240 based on an item identifier associated with each item). The retrieved set of data associated with each item may include item data, user data, order data, or any other suitable types of data that may be used to predict a likelihood that the item is a predictable availability item. As described above, a predictable availability item is associated with a measure of fluctuation of availability at different times of day at the retailer location that is at least a threshold measure and an availability of a predictable availability item at the retailer location is predictable for different times of the day. As also described above, items that are predictable availability items may be more likely to be prepared each day at the retailer location and to be priced below market cost to attract users and stimulate sales of other items than items that are not predictable availability items. For example, the online system 140 may retrieve 310 a set of data associated with each item to be included in the order describing whether the item is included in a “loss leader” or a “fresh made” item category, as well as a measure of fluctuation of an availability of the item at different times of day at the retailer location. Due to its fluctuating daily availability, an availability of a predictable availability item is also likely to be more important to the user than that of other items, such that information that may be used to predict a likelihood that an item to be included in the order is a predictable availability item may indicate whether previous orders including the item were placed primarily for the purpose of acquiring it. For example, the retrieved set of data associated with each item may indicate whether a refund issued for the item was associated with an issue, a cancellation, a complaint, or a low rating associated with one or more previous orders. In the above example, the set of data also may indicate whether a refund issued for the item was associated with one or more additional items being removed from one or more previous orders, whether the item was the first item added to one or more shopping lists, etc.

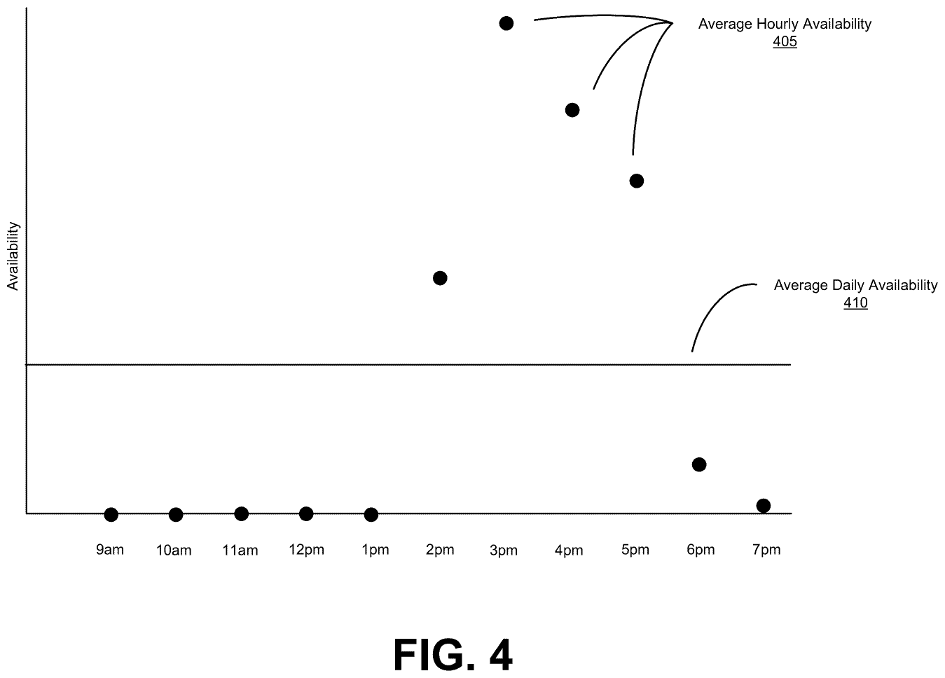

In embodiments in which the set of data associated with each item to be included in the order retrieved 310 by the online system 140 includes a measure of fluctuation of an availability of the item at different times of day at the retailer location, the fluctuation may be measured in various ways (e.g., a standard deviation, a range, a difference, a ratio, a rate, etc.). For example, a measure of fluctuation of an availability of an item at different times of day at the retailer location may correspond to a standard deviation computed based on data points describing the average availability of the item at the retailer location at different times of the day (e.g., for every hour, every 30 minutes, every 10 minutes, etc.). In the above example, the measure of fluctuation also may correspond to a range of the average availability computed based on the data points. FIG. 4 illustrates an example of fluctuations in an availability of an item at different times of day at a retailer location, in accordance with one or more embodiments. Suppose that the average hourly availabilities 405 and average daily availability 410 shown in FIG. 4 is for an item that is prepared each day at 2 p.m., such that its average hourly availability 405 is negligible before 2 p.m., peaks at 3 p.m., and decreases the rest of the day. In this example, the measure of fluctuation may correspond to a difference between a largest average hourly availability 405 of the item at the retailer location (at 3 p.m.) and an average daily availability 410 of the item at the retailer location. Alternatively, in the above example, the measure of fluctuation may correspond to a ratio of the largest average hourly availability 405 of the item at the retailer location to the average daily availability 410 of the item at the retailer location. As an additional example, a measure of fluctuation of an availability of an item at different times of day at the retailer location may correspond to a rate at which an average hourly availability 405 of the item changes throughout the day at the retailer location.

Referring again to FIG. 3, the online system 140 may then predict (e.g., using the prediction module 215) a likelihood that each item to be included in the order is a predictable availability item based on data associated with the item retrieved 310 by the online system 140. For example, suppose that a set of data associated with an item to be included in the order indicates whether refunds issued for the item were associated with issues, cancellations, complaints, or low ratings associated with previous orders, or with one or more additional items being removed from previous orders. In this example, the online system 140 may predict the likelihood that the item is a predictable availability item based on the set of data, in which the predicted likelihood is proportional to a number of times or a rate at which refunds issued for the item were associated with issues, cancellations, complaints, or low ratings associated with previous orders, or with one or more additional items being removed from previous orders. In the above example, suppose that the set of data associated with the item also indicates whether the item was the first item added to shopping lists and whether the item is included in a “loss leader” or a “fresh made” item category. Continuing with this example, the likelihood predicted by the online system 140 also may be proportional to a percentage of previous orders in which the item was the first item added to a shopping list and the likelihood may be higher if the item is included in a “loss leader” or a “fresh made” item category than if it is not. In the above example, if the set of data associated with the item also describes a measure of fluctuation of an availability of the item at different times of day at the retailer location, the likelihood predicted by the online system 140 also may be proportional to the measure of fluctuation.

The online system 140 may predict the likelihood that each item to be included in the order is a predictable availability item using a predictable availability item prediction model. The predictable availability item prediction model is a machine-learning model trained to predict a likelihood that an item is a predictable availability item. In some embodiments, the predictable availability item prediction model is a multi-task model that predicts the likelihood that each item to be included in the order is a predictable availability item. In other embodiments, the predictable availability item prediction model predicts the likelihood for a particular item to be included in the order. To use the predictable availability item prediction model, the online system 140 may access 315 (e.g., using the prediction module 215) the model (e.g., from the data store 240) and, for each item to be included in the order, apply 320 (e.g., using the prediction module 215) the model to a set of inputs to predict the likelihood that a corresponding item is a predictable availability item. The set of inputs may include various types of data associated with an item retrieved 310 by the online system 140. For example, the set of inputs may indicate whether refunds issued for an item were associated with issues, cancellations, complaints, or low ratings associated with previous orders, or with one or more additional items being removed from previous orders. In this example, the set of inputs also may indicate whether the item was the first item added to shopping lists and whether the item is included in a “loss leader” or a “fresh made” item category. Continuing with this example, the set of inputs also may describe a measure of fluctuation of an availability of the item at different times of day at the retailer location. Once the online system 140 applies 320 the predictable availability item prediction model to a set of inputs, the online system 140 may receive (e.g., via the prediction module 215) an output from the model indicating a likelihood that an item is a predictable availability item. Continuing with the above example, the output received by the online system 140 may correspond to a value, such as a percentage, a score, etc. that indicates or is proportional to the likelihood that the item is a predictable availability item.

In some embodiments, the predictable availability item prediction model may be trained by the online system 140 (e.g., using the machine-learning training module 230). The online system 140 may train the predictable availability item prediction model via supervised learning or using any other suitable technique or combination of techniques. The online system 140 may do so based on data (e.g., item data, user data, order data, etc.) associated with items included among the inventory of one or more retailers or retailer locations associated with the online system 140.

To illustrate an example of how the online system 140 may train the predictable availability item prediction model, suppose that the online system 140 receives a set of training examples. In this example, the set of training examples may include various attributes of items included among an inventory of a retailer location associated with the online system 140, such as whether refunds issued for each item were associated with issues, cancellations, complaints, or low ratings associated with previous orders, or with one or more additional items being removed from previous orders. In this example, the attributes of each item also may indicate whether the item was the first item added to shopping lists and whether the item is included in a “loss leader” or a “fresh made” item category. In the above example, the online system 140 also may receive labels which represent expected outputs of the predictable availability item prediction model, in which a label indicates whether an item is a predictable availability item. In this example, the label may indicate the item is a predictable availability item if a measure of fluctuation of an availability of the item at different times of day at the retailer location is at least a threshold measure. Continuing with this example, the online system 140 may then train the predictable availability item prediction model based on the attributes, as well as the labels by comparing its output from input data of each training example to the label for the training example.

The online system 140 then identifies 325 (e.g., using the identification module 214) a set of predictable availability items included among the item(s) in the order. The online system 140 may identify 325 the set of predictable availability items based on the predicted likelihood that each item is a predictable availability item. For example, the online system 140 may compare (e.g., using the identification module 214) a predicted likelihood that an item to be included in the order is a predictable availability item to a threshold likelihood and identify 325 the item as a predictable availability item if the likelihood is at least the threshold likelihood.

The online system 140 also or alternatively may receive (e.g., via the interface module 211) information from the user client device 100, a picker client device 110, or a retailer computing system 120 indicating whether an item to be included in the order is a predictable availability item. The online system 140 may receive this information in response to a prompt, a questionnaire, a survey, etc. that asks for information that may indicate whether the item is a predictable availability item (e.g., whether it is freshly prepared, whether its availability fluctuates throughout the day, an importance of its availability, etc.). For example, the online system 140 may generate (e.g., using the interface module 211) a prompt that asks the user whether any items to be included in the order are freshly prepared items. In this example, in response to sending (e.g., using the interface module 211) the prompt to the user client device 100 associated with the user, the online system 140 may receive (e.g., via the interface module 211) a response from the user client device 100 indicating whether one or more items to be included in the order are freshly prepared items and are therefore also likely to be predictable availability items. Alternatively, in the above example, if the prompt asks the user to verify whether the set of items to be included in the order that the online system 140 has identified 325 as predictable availability items are freshly prepared items, and the response from the user client device 100 verifies this, the response may also indicate the item is a predictable availability item. As an additional example, the online system 140 may generate a prompt that asks the user which items to be included in the order are items that the user needs rather than wants, and send the prompt to the user client device 100 associated with the user. In the above example, since an availability of a predictable availability item is also likely to be more important to the user than that of other items due to its fluctuating daily availability, a response to the prompt received from the user client device 100 identifying a set of items that the user needs also may indicate that each identified item is a predictable availability item.

The online system 140 may then identify (e.g., using the identification module 214) a set of future timeframes associated with the order. In embodiments in which the order is a delivery order, a future timeframe associated with the order may correspond to a delivery timeframe during which the order may be delivered to the user, while in embodiments in which the order is a pickup order, a future timeframe associated with the order may correspond to a pickup timeframe during which the order may be picked up by the user from the retailer location. Various types of future timeframes associated with the order may be identified by the online system 140. For example, the online system 140 may identify future timeframes associated with the order that include an expedited or priority timeframe (e.g., within the next hour) and a standard timeframe (e.g., between the next two hours and the next four hours), and one or more timeframes that span a specific number of hours (e.g., two or three hours). In this example, the timeframes identified by the online system 140 also may include an ETA-based timeframe (e.g., based on an estimated time that the user will arrive at the retailer location to pick up the order or an estimated time that a picker servicing the order will arrive at a delivery location to deliver the order). The online system 140 may identify the set of future timeframes associated with the order based on various types of information. Examples of such types of information include: the retailer location from which the item(s) to be included in the order is/are to be collected, a time associated with the order (e.g., time of day, day of the week, etc.), whether pickers are available to service the order, a number of items to be included in the order, a default timeframe associated with the user, or any other suitable types of information.

The online system 140 may then predict 330 (e.g., using the prediction module 215) an availability of each identified predictable availability item at the retailer location during a future timeframe. In some embodiments, the prediction module 215 also predicts 330 an availability of an item if the online system 140 has received information indicating the item is a predictable availability item. A predicted availability of a predictable availability item at the retailer location during a future timeframe may correspond to a likelihood that the predictable availability item is available at the retailer location during the future timeframe or a number of the predictable availability item predicted 330 to be available at the retailer location during the future timeframe. For example, the predicted availability of a predictable availability item at the retailer location during a future timeframe may describe a likelihood that the predictable availability item will be available at the retailer location when a picker will be collecting the predictable availability item from the retailer location based on the future timeframe (e.g., time of day, whether it is a pickup or a delivery timeframe, etc.). Alternatively, in the above example, the predicted availability may describe a number of the predictable availability item predicted 330 to be available at the retailer location when the picker will be collecting the predictable availability item from the retailer location based on the future timeframe.

The online system 140 may predict 330 the availability of each identified predictable availability item at the retailer location during a future timeframe based on a set of data associated with the predictable availability item. As described above, data associated with an item may include historical or current availability data associated with the item (e.g., for different retailer locations, times of day, days of the week, holidays, seasons, etc.). The online system 140 also may predict 330 the availability of each identified predictable availability item at the retailer location during a future timeframe based on information describing the future timeframe, the retailer location, or any other suitable types of information. For example, the online system 140 may predict 330 the availability of a predictable availability item at the retailer location during a future timeframe based on a time of day, day of the week, a holiday, a season, etc. associated with the future timeframe, an item identifier, item category, etc. associated with the predictable availability item, and a name of a retailer and a geographical region associated with the retailer location.

To illustrate an example of how the online system 140 may predict 330 the availability of an identified predictable availability item at the retailer location during a future timeframe, suppose that the set of data associated with the predictable availability item retrieved 310 by the online system 140 describes, for the retailer location, one or more quantities or rates associated with the predictable availability item. In this example, the quantity/quantities may correspond to a quantity of the predictable availability item that was previously or last restocked, purchased, or ordered, or a quantity of the predictable availability item that is currently available or scheduled to be restocked, etc., while the rate(s) may correspond to a rate at which it is restocked, ordered, purchased, etc. In the above example, the set of data also may include a time (e.g., a timestamp or a timespan) associated with each quantity or rate. Continuing with this example, the online system 140 may predict 330 an availability of the predictable availability item at the retailer location during a future timeframe that is proportional to a quantity of the predictable availability item that is currently available, a quantity of the predictable availability item that was previously, last, or scheduled to be restocked, and the rate at which it is restocked. In the above example, the predicted availability also may be proportional to a difference between a sum of the quantities of the predictable availability item that were purchased/ordered after the predictable availability item was previously/last restocked and a quantity of the predictable availability item that was previously/last restocked. Continuing with the above example, the predicted availability also may be inversely proportional to an amount of time between the time that the predictable availability item was previously, last, or scheduled to be restocked and the future timeframe. In the above example, if the set of data also includes real-time information describing quantities of the predictable availability item included in shopping lists associated with users, such that if each user places an order, the predictable availability item and any other items included in the shopping lists are to be collected from the retailer location, the predicted availability also may be inversely proportional to a sum of the quantities.

In various embodiments, the online system 140 predicts 330 the availability of an identified predictable availability item at the retailer location during multiple future timeframes. For example, suppose that the online system 140 has identified three future timeframes associated with the order. In this example, the online system 140 may, by default, predict 330 the availability of the predictable availability item at the retailer location during each of the future timeframes. Alternatively, in the above example, the online system 140 may predict 330 the availability of the predictable availability item at the retailer location during the future timeframes in response to receiving a selection of a future timeframe from the user client device 100, as further described below.

The online system 140 also may predict 330 the availability of an identified predictable availability item at the retailer location during a future timeframe using a retailer-timeframe availability model. The retailer-timeframe availability model is a machine-learning model trained to predict 330 the availability of a predictable availability item at the retailer location during a future timeframe. In some embodiments, the retailer-timeframe availability model is a multi-task model that predicts 330, for the retailer location during each of a set of future timeframes, the availability of each identified predictable availability item. In other embodiments, the retailer-timeframe availability model predicts 330, for the retailer location during a particular future timeframe, the availability of a particular identified predictable availability item.

To use the retailer-timeframe availability model, the online system 140 may access (e.g., using the prediction module 215) the model (e.g., from the data store 240) and apply (e.g., using the prediction module 215) the model to a set of inputs. The set of inputs may include various types of data associated with a predictable availability item, information describing a future timeframe, the retailer location, or any other suitable types of information. For example, the set of inputs may include a time of day, day of the week, a holiday, a season, etc. associated with a future timeframe, an item identifier, item category, etc. associated with a predictable availability item, and a name of the retailer and a geographical region associated with the retailer location. As an additional example, the set of inputs may include historical or current availability data associated with a predictable availability item at the retailer location (e.g., for different times of day, days of the week, holidays, seasons, etc.). In this example, the set of inputs may include a time that the predictable availability item was last found at the retailer location, a time that it was last not found at the retailer location, a rate at which it is found at the retailer location, and its popularity at the retailer location. In the above example, the set of inputs also may include one or more quantities associated with the predictable availability item for the retailer location (e.g., a quantity of the predictable availability item that was previously or last restocked, purchased, or ordered, a quantity of the predictable availability item that is currently available or scheduled to be restocked, etc.) and a time (e.g., a timestamp or a timespan) associated with each quantity. In this example, the set of inputs also may include, for the retailer location, one or more rates associated with the predictable availability item (e.g., a rate at which it is restocked, ordered, purchased, etc.) and a time (e.g., a timestamp or a timespan) associated with each rate. Additionally, in the above example, the set of inputs may include real-time information describing quantities of the predictable availability item included in shopping lists associated with users, such that if each user places an order, the predictable availability item and any other items included in the shopping lists are to be collected from the retailer location.

Once the online system 140 applies the retailer-timeframe availability model to a set of inputs, the online system 140 may receive (e.g., via the prediction module 215) an output from the model corresponding to the predicted availability of an identified predictable availability item at the retailer location during a future timeframe. Continuing with the above example, the output received by the online system 140 may correspond to a value, such as a percentage, a score, etc. that indicates or is proportional to the predicted availability of the predictable availability item at the retailer location during a future timeframe. In embodiments in which the online system 140 receives information indicating an item is a predictable availability item, the online system 140 also predicts 330 an availability of the item in a manner analogous to that described above.

In some embodiments, the retailer-timeframe availability model may be trained by the online system 140 (e.g., using the machine-learning training module 230). The online system 140 may train the retailer-timeframe availability model via supervised learning or using any other suitable technique or combination of techniques based on data (e.g., item data, user data, order data, etc.) associated with items included among the inventory of one or more retailers or retailer locations associated with the online system 140. Examples of such types of data include: historical or current availability data associated with predictable availability items (e.g., for different retailer locations, times of day, days of the week, holidays, seasons, etc.), historical supply and demand data associated with the online system 140 (e.g., information describing shifts in demand from users, information describing changes in supply chains, etc.), or any other suitable types of data. The online system 140 also may train the retailer-timeframe availability model based on additional types of information, such as user data (e.g., historical interaction information), information describing previous timeframes, retailer locations, or any other suitable types of information.

To illustrate an example of how the online system 140 may train the retailer-timeframe availability model, suppose that the online system 140 receives a set of training examples. In this example, the set of training examples may include various attributes of predictable availability items included among an inventory of the retailer location, such as times that each predictable availability item was found at the retailer location, times that it was not found at the retailer location, a rate at which it was found at the retailer location, and its popularity at the retailer location. In this example, the attributes also may include one or more quantities associated with each predictable availability item (e.g., a quantity of the predictable availability item that was previously restocked, purchased, or ordered, etc.), one or more rates associated with the predictable availability item (e.g., a rate at which it was restocked, ordered, purchased, etc.), and a time (e.g., a timestamp or a timespan) associated with each quantity or rate. Additionally, in the above example, the attributes of each predictable availability item also may include attributes that may have potentially affected the availability of each predictable availability item at the retailer location (e.g., a quantity of the predictable availability item included in shopping lists associated with users, such that if each user placed an order, the predictable availability item and any other items included in the shopping lists were collected from the retailer location). In the above example, the online system 140 also may receive labels which represent expected outputs of the retailer-timeframe availability model, in which a label indicates an availability of a predictable availability item at the retailer location during a timeframe (e.g., as a value, a percentage, a score, etc. that corresponds to or is proportional to the availability). Continuing with this example, the online system 140 may then train the retailer-timeframe availability model based on the attributes, as well as the labels by comparing its output from input data of each training example to the label for the training example.

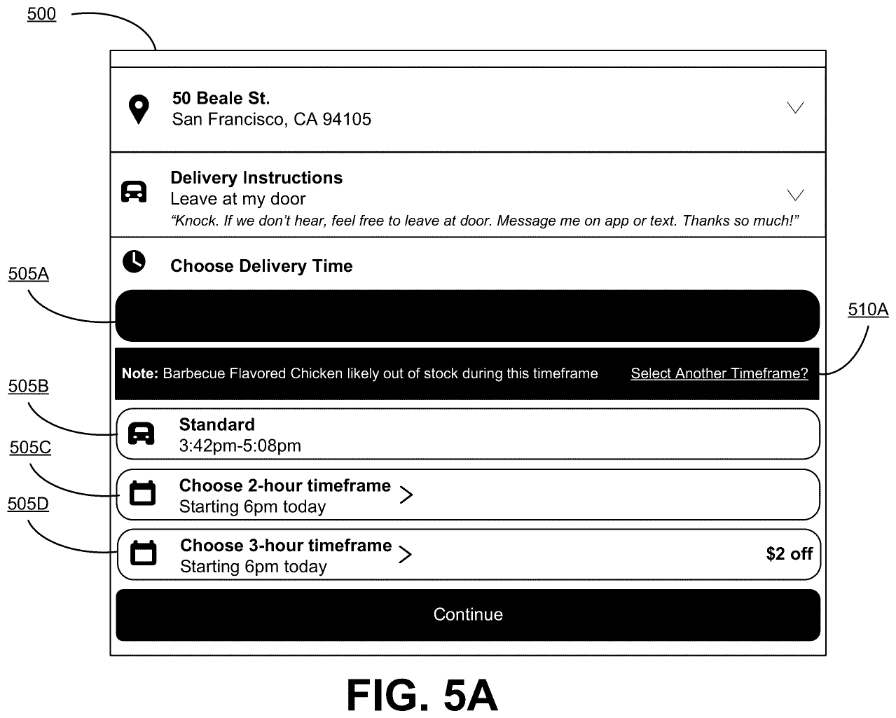

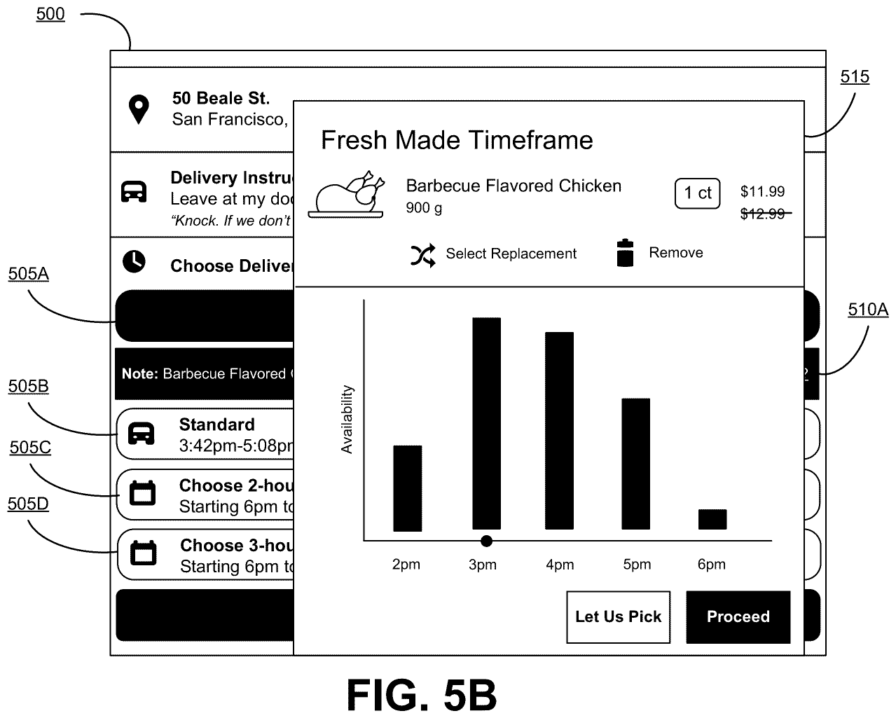

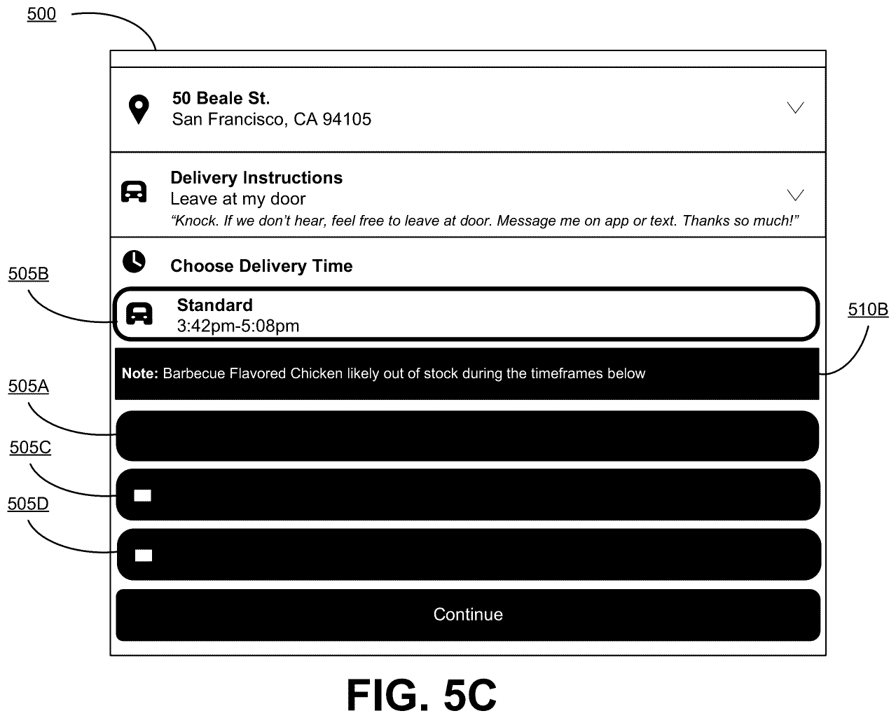

Once the online system 140 predicts 330, for the retailer location during a future timeframe, an availability of each identified predictable availability item, the online system 140 may update 335 (e.g., using the interface module 211) the ordering interface to include information describing the predicted availability. In embodiments in which the online system 140 receives information indicating an item is a predictable availability item and predicts 330 an availability of the item, the online system 140 updates 335 the ordering interface to include information describing the predicted availability. The online system 140 may update 335 the ordering interface with text, images (e.g., graphs), videos, animations, or any other suitable types of content. FIGS. 5A-5C illustrate examples of updates to a user interface to include information describing a predicted availability of a predictable availability item at a retailer location during one or more future timeframes, in accordance with one or more embodiments. Referring first to the example of FIG. 5A, suppose that during a future timeframe 505A that is between the next 48 and 58 minutes, the online system 140 has predicted 330 an availability of an identified predictable availability item corresponding to barbecue flavored chicken at the retailer location and that the predicted availability is less than a threshold predicted availability. In this example, if the user selects this future timeframe 505A, the online system 140 may update 335 the ordering interface 500 to include a note 510A indicating that the barbecue flavored chicken will likely be out of stock at the retailer location during the selected future timeframe 505A. In the above example, the note 510A also may suggest that the user select a different timeframe 505. In embodiments in which the order includes multiple predictable availability items, the online system 140 updates 335 the ordering interface 500 to include information describing the predicted availabilities of the predictable availability items at the retailer location during a future timeframe 505 (e.g., by including an average predicted availability of the predictable availability items or a predicted availability of each predictable availability item).

The online system 140 also may update 335 the ordering interface 500 to include information describing the predicted availability of each identified predictable availability item at the retailer location during multiple future timeframes 505. Continuing with the above example, in response to receiving a request from the user client device 100 associated with the user to select a different timeframe 505, the online system 140 may update 335 the ordering interface 500 to include a window 515 with a graph illustrating the predicted availability of the barbecue flavored chicken during different timeframes 505, as shown in FIG. 5B. In this example, the window 515 also may include various options associated with the barbecue flavored chicken (e.g., to select a replacement, to remove it, etc. via a button or other interactive element) or the timeframes 505 (e.g., to select a different timeframe 505 via a slider or other interactive element, to allow the online system 140 to select a different timeframe 505 via a button or other interactive element, etc.). Alternatively, in the above example, a future timeframe 505 associated with the greatest predicted availability may be selected by default in the ordering interface 500 and the online system 140 may update 335 the ordering interface 500 to include the window 515 in response to receiving a selection of a different future timeframe 505. As another alternative, as shown in FIG. 5C, the future timeframe 505B associated with the greatest predicted availability may be highlighted and the future timeframes 505A-D may be positioned within the ordering interface 500 based on their associated predicted availabilities, such that the future timeframe 505B associated with the greatest predicted availability may be highlighted and placed in a most prominent position of the ordering interface 500. Furthermore, as shown in FIG. 5C, other future timeframes 505A, 505C, and 505D may be presented below a note 510B indicating that the barbecue flavored chicken will likely be out of stock at the retailer location during these future timeframes 505A, 505C, and 505D. In this example, the online system 140 may update 335 the ordering interface 500 to include the window 515 in response to receiving a selection of a future timeframe 505A, 505C, or 505D that is not highlighted or in the most prominent position of the ordering interface 500.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
sending, from an online system to a client device associated with a user of the online system, instructions causing the client device to display a user interface for placing an order comprising one or more items to be collected from a retailer location;
responsive to receiving a request from the client device to place the order via the user interface, retrieving a set of data associated with each item of the one or more items;
accessing a machine-learning model trained to predict a likelihood that an item is a predictable availability item, wherein the machine-learning model is trained by:
receiving data associated with a plurality of items included among an inventory of the retailer location,
receiving, for each of the plurality of items, a label indicating whether a measure of fluctuation of an availability of each item at different times of day at the retailer location is at least a threshold measure, and
training the machine-learning model based at least in part on the data and the label for each of the plurality of items;
for each item of the one or more items, applying the machine-learning model to predict the likelihood that a corresponding item is a predictable availability item, wherein the predicted likelihood is based at least in part on the set of data associated with the corresponding item;
identifying a set of predictable availability items included among the one or more items, wherein the identifying is based at least in part on the likelihood predicted for each item of the one or more items;
for each predictable availability item of the set of predictable availability items, predicting the availability of a corresponding predictable availability item at the retailer location during a future timeframe, wherein the availability is predicted based at least in part on the set of data associated with the corresponding predictable availability item; and
updating the user interface to include information describing the predicted availability of each predictable availability item of the set of predictable availability items at the retailer location during the future timeframe, wherein the updating causes the client device to display the updated user interface.

2. The method of claim 1, wherein retrieving the set of data associated with each item of the one or more items comprises retrieving one or more of: whether a refund issued for a corresponding item is associated with an issue associated with a previous order, whether a refund issued for a corresponding item is associated with a cancellation of a previous order, whether a refund issued for a corresponding item is associated with a complaint associated with a previous order, whether a refund issued for a corresponding item is associated with a low rating associated with a previous order, whether a refund issued for a corresponding item is associated with one or more additional items being removed from a previous order, whether a corresponding item was a first item added to a shopping list, whether a corresponding item is categorized as a loss leader item, or whether a corresponding item is categorized as a fresh made item.

3. The method of claim 1, wherein receiving the label indicating the measure of fluctuation of the availability of each item at different times of day at the retailer location includes receiving one or more of: a standard deviation, a range, a difference, a ratio, or a rate.

4. The method of claim 1, further comprising:
accessing an additional machine-learning model trained to predict the availability of a predictable availability item at the retailer location during the future timeframe, wherein the additional machine-learning model is trained by:
receiving historical availability data associated with a plurality of predictable availability items included among the inventory of the retailer location, and
training the additional machine-learning model based at least in part on the historical availability data; and
for each predictable availability item of the set of predictable availability items, applying the additional machine-learning model to predict the availability of a corresponding predictable availability item at the retailer location during the future timeframe, wherein the additional machine-learning model is applied to the set of data associated with the corresponding predictable availability item.

5. The method of claim 4, wherein training the additional machine-learning model is further based at least in part on historical supply and demand data associated with the online system.

6. The method of claim 4, further comprising:
receiving a selection of the future timeframe from the client device, wherein the predicted availability of the set of predictable availability items at the retailer location during the future timeframe is less than a threshold predicted availability;
for each predictable availability item of the set of predictable availability items, applying the additional machine-learning model to predict the availability of the corresponding predictable availability item at the retailer location during one or more additional future timeframes, wherein the additional machine-learning model is applied to the set of data associated with the corresponding predictable availability item; and
updating the user interface to include information describing the predicted availability of each predictable availability item of the set of predictable availability items at the retailer location during the one or more additional future timeframes.

7. The method of claim 6, wherein updating the user interface comprises displaying, as a graph, the predicted availability of each predictable availability item of the set of predictable availability items at the retailer location during the one or more additional future timeframes.

8. The method of claim 4, further comprising:
receiving information describing a current availability of each predictable availability item of the set of predictable availability items at the retailer location.

9. The method of claim 8, wherein retrieving the set of data associated with the corresponding predictable availability item comprises retrieving information that describes the current availability of the corresponding predictable availability item at the retailer location.

10. The method of claim 1, wherein retrieving the set of data associated with the corresponding item comprises retrieving information describing the measure of fluctuation of the availability of the corresponding item at different times of day at the retailer location.

11. A computer program product comprising a non-transitory computer-readable storage medium having instructions encoded thereon that, when executed by a processor, cause the processor to perform steps comprising:
sending, from an online system to a client device associated with a user of the online system, instructions causing the client device to display a user interface for placing an order comprising one or more items to be collected from a retailer location;
responsive to receiving a request from the client device to place the order via the user interface, retrieving a set of data associated with each item of the one or more items;
accessing a machine-learning model trained to predict a likelihood that an item is a predictable availability item, wherein the machine-learning model is trained by:
receiving data associated with a plurality of items included among an inventory of the retailer location,
receiving, for each of the plurality of items, a label indicating whether a measure of fluctuation of an availability of each item at different times of day at the retailer location is at least a threshold measure, and
training the machine-learning model based at least in part on the data and the label for each of the plurality of items;
for each item of the one or more items, applying the machine-learning model to predict the likelihood that a corresponding item is a predictable availability item, wherein the predicted likelihood is based at least in part on the set of data associated with the corresponding item;
identifying a set of predictable availability items included among the one or more items, wherein the identifying is based at least in part on the likelihood predicted for each item of the one or more items;
for each predictable availability item of the set of predictable availability items, predicting the availability of a corresponding predictable availability item at the retailer location during a future timeframe, wherein the availability is predicted based at least in part on the set of data associated with the corresponding predictable availability item; and
updating the user interface to include information describing the predicted availability of each predictable availability item of the set of predictable availability items at the retailer location during the future timeframe, wherein the updating causes the client device to display the updated user interface.

12. The computer program product of claim 11, wherein retrieving the set of data associated with each item of the one or more items comprises retrieving one or more of: whether a refund issued for a corresponding item is associated with an issue associated with a previous order, whether a refund issued for a corresponding item is associated with a cancellation of a previous order, whether a refund issued for a corresponding item is associated with a complaint associated with a previous order, whether a refund issued for a corresponding item is associated with a low rating associated with a previous order, whether a refund issued for a corresponding item is associated with one or more additional items being removed from a previous order, whether a corresponding item was a first item added to a shopping list, whether a corresponding item is categorized as a loss leader item, or whether a corresponding item is categorized as a fresh made item.

13. The computer program product of claim 11, wherein receiving the label indicating the measure of fluctuation of the availability of each item at different times of day at the retailer location includes receiving one or more of: a standard deviation, a range, a difference, a ratio, or a rate.

14. The computer program product of claim 11, wherein the computer-readable storage medium further has instructions encoded thereon that, when executed by the processor, cause the processor to perform steps comprising:
accessing an additional machine-learning model trained to predict the availability of a predictable availability item at the retailer location during the future timeframe, wherein the additional machine-learning model is trained by:
receiving historical availability data associated with a plurality of predictable availability items included among the inventory of the retailer location, and
training the additional machine-learning model based at least in part on the historical availability data; and
for each predictable availability item of the set of predictable availability items, applying the additional machine-learning model to predict the availability of a corresponding predictable availability item at the retailer location during the future timeframe, wherein the additional machine-learning model is applied to the set of data associated with the corresponding predictable availability item.

15. The computer program product of claim 14, wherein training the additional machine-learning model is further based at least in part on historical supply and demand data associated with the online system.

16. The computer program product of claim 14, wherein the computer-readable storage medium further has instructions encoded thereon that, when executed by the processor, cause the processor to perform steps comprising:
receiving a selection of the future timeframe from the client device, wherein the predicted availability of the set of predictable availability items at the retailer location during the future timeframe is less than a threshold predicted availability;
for each predictable availability item of the set of predictable availability items, applying the additional machine-learning model to predict the availability of the corresponding predictable availability item at the retailer location during one or more additional future timeframes, wherein the additional machine-learning model is applied to the set of data associated with the corresponding predictable availability item; and
updating the user interface to include information describing the predicted availability of each predictable availability item of the set of predictable availability items at the retailer location during the one or more additional future timeframes.

17. The computer program product of claim 16, wherein updating the user interface comprises displaying, as a graph, the predicted availability of each predictable availability item of the set of predictable availability items at the retailer location during the one or more additional future timeframes.

18. The computer program product of claim 14, wherein the computer-readable storage medium further has instructions encoded thereon that, when executed by the processor, cause the processor to perform steps comprising:
receiving information describing a current availability of each predictable availability item of the set of predictable availability items at the retailer location.

19. The computer program product of claim 18, wherein retrieving the set of data associated with the corresponding predictable availability item comprises retrieving information that describes the current availability of the corresponding predictable availability item at the retailer location.

20. A computer system comprising:
a processor; and
a non-transitory computer-readable storage medium storing instructions that, when executed by the processor, perform actions comprising:
sending, from an online system to a client device associated with a user of the online system, instructions causing the client device to display a user interface for placing an order comprising one or more items to be collected from a retailer location;
responsive to receiving a request from the client device to place the order via the user interface, retrieving a set of data associated with each item of the one or more items;
accessing a machine-learning model trained to predict a likelihood that an item is a predictable availability item, wherein the machine-learning model is trained by:
receiving data associated with a plurality of items included among an inventory of the retailer location,
receiving, for each of the plurality of items, a label indicating whether a measure of fluctuation of an availability of each item at different times of day at the retailer location is at least a threshold measure, and
training the machine-learning model based at least in part on the data and the label for each of the plurality of items;
for each item of the one or more items, applying the machine-learning model to predict the likelihood that a corresponding item is a predictable availability item, wherein the predicted likelihood is based at least in part on the set of data associated with the corresponding item;
identifying a set of predictable availability items included among the one or more items, wherein the identifying is based at least in part on the likelihood predicted for each item of the one or more items;
for each predictable availability item of the set of predictable availability items, predicting the availability of a corresponding predictable availability item at the retailer location during a future timeframe, wherein the availability is predicted based at least in part on the set of data associated with the corresponding predictable availability item; and
updating the user interface to include information describing the predicted availability of each predictable availability item of the set of predictable availability items at the retailer location during the future timeframe, wherein the updating causes the client device to display the updated user interface.
